(19) United States
(12) Patent Application Publication
(10) Pub. No.: US 2025/0333128 A1
(43) Pub. Date: Oct. 30, 2025

(54) Method for Producing an Assembly, and Assembly

(71) Applicant: Bayerische Motoren Werke Aktiengesellschaft, Muenchen (DE)

(72) Inventors: Dominik EXNER, Otterfing (DE); Niko FONTEIN, Unterschleissheim (DE); Matthias STANGL, Friedberg (DE)

(21) Appl. No.: 19/186,764

(22) Filed: Apr. 23, 2025

(30) Foreign Application Priority Data
Apr. 24, 2024 (DE) 10 2024 111 431.2

(51) Int. Cl. B62D 65/02; B62D 27/02

(52) U.S. Cl. CPC B62D 65/026; B62D 27/026

(57) ABSTRACT

A method for producing an assembly for a vehicle, wherein at least two subassemblies are aligned with one another in that the subassemblies are each arranged on a component, and to an assembly for a vehicle.

### CROSS REFERENCE TO RELATED APPLICATION

This application claims priority under 35 U.S.C. § 119 from German Patent Application No. 10 2024 111 431.2, filed Apr. 24, 2024, the entire disclosure of which is herein expressly incorporated by reference.

### BACKGROUND AND SUMMARY

The present disclosure relates to a method for producing an assembly for a vehicle, and to an assembly for a vehicle.

In current vehicle body construction, various components such as side members, undercarriage, side walls, B-pillar, roof bows etc. are conventionally joined together to form a body in white. These individual parts consist of different materials, resulting in a material mix in the body in white. When joining the components to form the body in white, the components are usually aligned via devices such as clamping frames or gages in order that they are in the correct position with respect to one another before they are finally joined for example by way of spot welding methods.

Preassembled large modules, for example front end, rear end or undercarriage, cannot be hot joined and also cannot be fully sealed off reliably. In the prior art, it has become established practice to adhesively bond such large modules to one another. Before the adhesive bond is created, the components or large modules to be adhesively bonded are conventionally positioned with respect to one another with the aid of a separate device. Such devices for positioning the individual parts are very complicated and expensive to produce and have to comply with very strict requirements in order that the components aligned thereon and the subsequent body in white can comply with specified tolerances.

The present disclosure addresses the problem of specifying an aligning concept and specifying a method for producing an assembly or an assembly with which the drawbacks of the prior art are overcome.

To solve this problem, the disclosure proposes a method for producing an assembly, wherein at least two subassemblies are aligned with one another in that the subassemblies are each arranged on a component. This affords the advantage that it is possible to dispense with additional positioning aids, such as gages etc., resulting in a rational and efficient production process.

Furthermore, in an aligning position, each subassembly can be aligned on the component via positioning aids. Positioning aids may be, for example, centering pins or conical tips, which are selectively arranged on the subassembly and/or on the component and pass into corresponding apertures, for example holes, in the other component in each case, i.e. the component or subassembly. To compensate for tolerances, it is also possible for slots to be provided.

Furthermore, to transfer the individual subassemblies into an aligning position with respect to one another, each subassembly can be aligned on the component. In other words, in order to align two subassemblies with one another, a first subassembly is connected in an aligning position to the component. Then, the second subassembly is connected in its aligning position to the component. In this way, the two subassemblies are correctly aligned with one another automatically such that the subassemblies are correctly aligned or positioned with respect to one another.

In a further step, a materially bonded connection between the subassemblies may be produced. This affords the advantage that the subassemblies can be made from very different materials which are connected via the materially bonded connection, for example an adhesive bond.

Alternatively or additionally, a force-fitting connection between the subassemblies may be produced. Furthermore, this force-fitting connection can also be produced between the subassemblies and the component. As a result of this additional, second mechanical connecting technique with connecting elements, for example by screw connection, handling stability of the assembly or of the body in white is created particularly early in the joining process, such that the assembly or the body in which can be moved and repositioned directly after joining, without it being necessary to wait while the adhesive cures.

The arrangement of the mechanical connecting elements should be chosen with support bases that are as large as possible, such that it is possible to reduce the requirement for the forces of the connecting elements, for example the screwing forces, and for the size of the connecting elements or the screw size. In this case, the greater the distance between two adjacent connecting elements, the smaller the forces that act on the connecting elements and the smaller the forces that can be chosen for the connecting elements in the dimensioning thereof. Furthermore, the farther apart two adjacent connecting elements are from one another, the lower the requirement that can be placed on tolerance deviations.

The force-fitting connection can be undone after a predetermined period of time has elapsed. A predetermined period of time corresponds in this case to the time until the materially bonded connection has reached a sufficient strength. After the predetermined period of time has elapsed, the assembly can be repositioned without there being the risk of the subassemblies shifting out of their position with respect to one another. If an adhesive bond is chosen as the materially bonded connection, the predetermined period of time corresponds substantially to the open time of the adhesive. If the force-fitting connection is created for example by screws, the connecting elements or the screws can be loosened and removed again after the predetermined period of time has elapsed. This affords the advantage that the overall weight of the assembly, and thus also of the body and of the finished vehicle, can be kept at a low level and is not unnecessarily increased. Furthermore, the connecting elements, for example the screws, can be reused for subsequent assemblies, thereby increasing the sustainability of the method.

Moreover, the component itself can be in the form of a subassembly. This component can subsequently be joined together from other individual parts.

Moreover, the subassembly can be in the form of a large module. Large modules according to the disclosure may be, for example, a preassembled front end, a preassembled central part, for example an undercarriage, and/or a preassembled rear end.

In a further aspect, the disclosure relates to an assembly having at least two subassemblies which are aligned with one another, wherein each subassembly is arranged on a component.

Furthermore, in an aligning position, each subassembly can be arranged on the component via positioning aids.

Furthermore, the subassemblies can be connected via a materially bonded and/or force-fitting connection. In a further alternative, the materially bonded and/or force-fitting connection can be produced between the subassemblies and/or between the subassemblies and the component.

The method according to the disclosure and the device according to the disclosure afford the advantage that a novel aligning concept can be introduced, in which the large modules of front end, undercarriage, and rear end can be positioned with respect to one another via geometric features, for example positioning aids or clearances in the form of slots or circular bores, in the component lateral frame. As a result, bodies or bodies in white can be produced in a particularly advantageous manner, wherein the assembly is then in the form of a body. In body construction, the lateral frame defines the decisive basis for the vehicle as a whole. By way of the claimed vehicle aligning concept via component-integrated features or positioning aids, the manufacturing process for bodies is simplified and the need for investment in plant engineering such as clamping frames and the like is reduced.

### BRIEF DESCRIPTION OF THE DRAWINGS

The disclosure will be described in more detail in the following text with reference to the figures.

FIG. 1 shows a perspective side view of an assembly.

FIG. 2 shows a perspective side view of an alternative embodiment of an assembly.

### DETAILED DESCRIPTION OF THE DRAWINGS

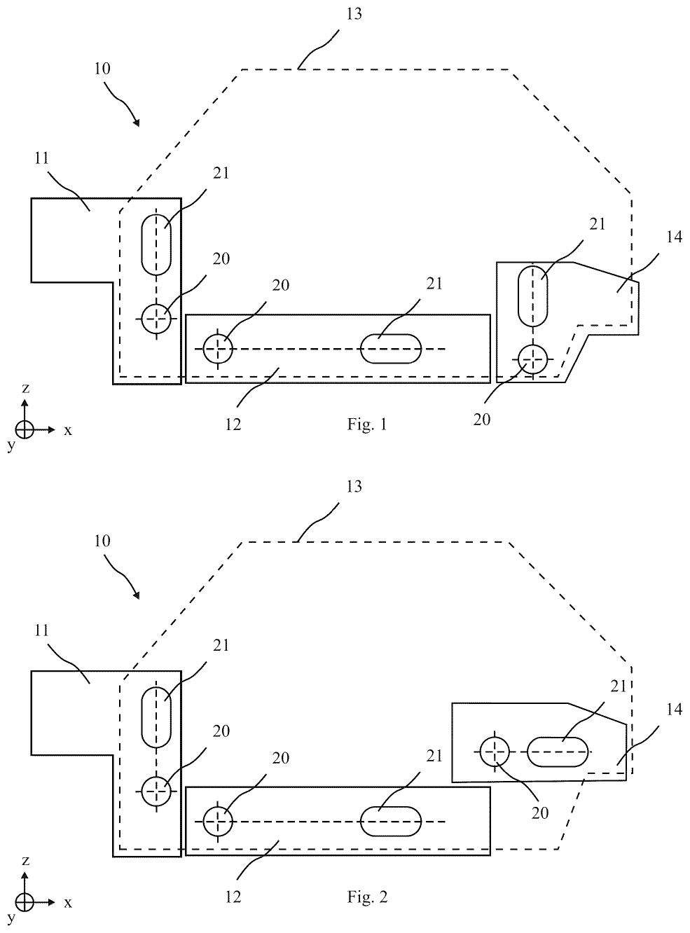

A tolerance and aligning concept for large modules is shown in FIG. 1. The assembly 10 comprises a first subassembly 11, which is in the form, for example, of a large module front end here. A Iso illustrated is a further subassembly 12 as a second subassembly, in the form, for example, of a large module central part or large module undercarriage in the figure. A third subassembly 14 is illustrated in the form, for example, of a large module rear end. Each of the subassemblies 11, 12, 14 is connected via positioning aids 20, 21 to a component 13, illustrated in the form, for example, of an assembly lateral frame here. The positioning aids may be, for example, positioning pins which are arranged, for example, on the large module front end 11 and pass into apertures, or holes 20 or slots 21, which are provided in the component 13, or in the lateral frame. Of course, the positioning pins and pins can also provided on the lateral frame 13 and pass into openings 20 and 21 in the large module front end.

The positioning aids 20 are so-called full fixtures. Full fixtures fix the subassemblies 11, 12, 14 in the vehicle longitudinal direction x and in the vehicle vertical direction z with respect to the component 13. The positioning aids 21 illustrated in the form of slots 21 fix the subassemblies 11, 12,14 in the vehicle longitudinal direction x or in the vehicle vertical direction z with respect to the component 13. This allows freedom of movement and thus tolerance compensation in the unfixed direction, i.e. in the vehicle vertical direction z or vehicle longitudinal direction x. For each subassembly 11, 12, 14, at least two positioning aids are required in order to prevent rotation about the vehicle transverse axis y.

Connecting elements for establishing a force-fitting connection are not illustrated in the figure. Preferably, however, the connecting elements should be arranged in the subassemblies 11, 12, 14 or the lateral frame 13 with high strength values. Such positions would be, for example, in the large module front end, the lower region of the end wall and the region in which the strut support of the front wheel suspension is supported. In the lateral frame 13, connecting elements are preferably arranged in the region of the footwell at the front, in the overlapping region of the A-pillar with the large module front end 11 or in the region of a B-pillar that is not illustrated in the figure.

Illustrated between the first subassembly 11 and the second subassembly 12 is an adhesive gap K 1. Illustrated between the second subassembly 12 and the third subassembly 14 is a second adhesive gap K 2. In addition to their function of establishing a materially bonded connection between the subassemblies 11 and 12, and 12 and 14, respectively, the adhesive gaps also have a tolerance compensation purpose. Furthermore, the adhesive can also be used to close up cavities and thus to seal off the subassemblies 11, 12, 14 and the component 13, in order to protect the subassemblies 11, 12, 14, the component 13 and ultimately the assembly 10 from corrosion. As a result, it is possible to replace the use of polyvinyl chloride (PVC) as sealing compound.

FIG. 2 shows an alternative embodiment to the assembly in FIG. 1, wherein the same reference signs designate the same components. The assembly 10 shown in FIG. 2 differs from the assembly shown in FIG. 1 by way of the shape of the large module rear end 14, which is arranged at least partially above the large module undercarriage 12.

What is claimed is:

1. A method for producing an assembly for a vehicle, wherein at least two subassemblies are aligned with one another in that the subassemblies are each arranged on a component.

2. The method according to claim 1, wherein
in an aligning position, each subassembly is aligned on the component via positioning aids.

3. The method according to claim 2, wherein
to transfer the individual subassemblies into an aligning position with respect to one another, each subassembly is aligned on the component.

4. The method according to claim 1, comprising:
establishing a materially bonded connection between the subassemblies.

5. The method according to claim 1, comprising:
establishing a force-fitting connection between the subassemblies.

6. The method according to claim 1, wherein
the component is a subassembly.

7. The method according to claim 1, wherein
the subassembly is a large module.

8. The method according to claim 1, wherein
the first subassembly is a front end, the second assembly is an undercarriage, and the third component is a lateral frame.

9. A n assembly having at least two subassemblies which are aligned with one another, wherein the subassemblies are each arranged on a component.

10. The assembly according to claim 9, wherein
in an aligning position, each subassembly is arranged on the component via positioning aids.

11. The assembly according to claim 10, wherein
the subassemblies are connected via a materially bonded and/or force-fitting connection.
